(19) United States
(12) Patent Application Publication
(10) Pub. No.: US 2020/0302831 A1
(43) Pub. Date: Sep. 24, 2020

(54) HIGH DURABILITY DIGITALLY PRINTED OUTDOOR SIGNAGE AND PROCESS

(71) Applicant: Rhino Marking & Protection Systems, Minneapolis, MN (US)

(72) Inventors: Doug Tenpas, Bloomington, MN (US); Josh Stangler, Wells, MN (US); Scott Landes, Bloomington, MN (US)

(21) Appl. No.: 16/822,806

(22) Filed: Mar. 18, 2020

Related U.S. Application Data
(60) Provisional application No. 62/820,645, filed on Mar. 19, 2019.

(51) Int. Cl. G09F 7/00; B41M 5/00; B41M 5/52

(52) U.S. Cl. CPC G09F 7/002; B41M 5/5209; B41M 5/0017

(57) ABSTRACT

Exterior signage comprised of a thermoplastic polymer substrate coated with an aliphatic urethane composition to provide an acceptable interface layer for an ink material applied to the interface layer, which is encapsulated with an aliphatic urethane composition overcoat to protect the ink material and thermoplastic polymer substrate from natural outdoor environmental conditions over an extended period of time of up to 10 years or more.

### RELATED APPLICATION

The present application claims the benefit of U.S. Provisional Application No. 62/820,645 entitled “HIGH DURABILITY DIGITALLY PRINTED OUTDOOR SIGNAGE AND PROCESS”, filed Mar. 19, 2019, which is incorporated herein by reference in its entirety.

### TECHNICAL FIELD

The present invention relates to outdoor signage, more particularly outdoor signage comprised of a thermoplastic polymer substrate material coated with a bonding layer to provide an acceptable interface for digital ink printing with the bonding layer, and the ink layer having an overtop coating to protect the ink and pigments in the thermoplastic polymer substrate material from environmental conditions, particularly high-density polyethylene, acrylonitrile butadiene styrene and/or thermoplastic polyolefin.

### BACKGROUND

High-density polyethylene (HDPE) is a thermoplastic polymer product from the monomer ethylene having a density from 0.93 g/cm³ to 0.97 g/cm³ that is commonly used for many applications due to its large strength-to-density ratio. Due to little branching, HDPE resins have excellent tensile strength, abrasion resistance, stress crack resistance, and chemical resistance and can withstand somewhat higher temperatures (120° C./248° F.) for short periods of time.

HDPE composition sheets are commonly used for signage, as the HDPE resins are compatible with colorants to provide colored signage, and HDPE sheets can be stacked providing the ability to engrave the signage for different colorings that may be layered upon each other. One problem associated with HDPE is that HDPE resins often exhibit high warpage, particularly when they are used with certain colorants or pigments and exposed to environmental conditions, such as exposure to ultraviolet light, high temperatures, temperature cycling between low and high temperatures, water and wind exposure, exhaust from diesel and gas combustion, and the like.

Many new pigments have been developed for HDPE coloration. See, for example, U.S. Pat. Nos. 6,555,604, 7,153,358 and 8,207,248. These new pigments may offer reduced warpage to molded articles from the colored HDPE. However, the use of colorants still subjects the HDPE composition to premature warpage, fading and the like when exposed to environmental conditions. Additionally, the stacking of different colored HDPE sheets to provide signage with various desired colors increases the cost in signage for each desired color.

Other thermoplastic polymers are also used for signage, including acrylonitrile butadiene styrene (ABS), thermoplastic polyolefin (TOP) and the like. ABS is a common thermoplastic polymer made by polymerizing styrene and acrylonitrile in the presence of polybutadiene. The proportions can vary from 15 to 35% acrylonitrile, 5 to 30% butadiene and 40 to 60% styrene. TPO is a polymer/filler blend usually consisting of some fraction of a thermoplastic, an elastomer or rubber, and usually a filler. Other common thermoplastics used for outdoor signage include polycarbonate and acrylics.

A problem with thermoplastics is that any liquid material having a dyne level equal to or higher than the thermoplastic's dyne level will result in a lack of wetting and compatability, such that a liquid material will not adhere to the thermoplastic material. For instance, HDPE compositions have a surface tension that is about 31 dynes/cm, such that any liquid material having a dyne level equal to or higher than the HDPE material's dyne level will result in a lack of wetting and compatibility, such that the liquid material will not adhere to the HDPE material. The lack of adhering to the thermoplastic material is further enhanced in harsh environments, such as environments having high temperature cycling.

Accordingly, there is a need in the industry for cost-effective, high durability signage that is water and chemical resistant, such that the signage has reduced warpage and/or fading when exposed to all weather types and environmental conditions, including ultraviolet light, high temperatures, low temperatures, temperature cycling between low and high temperatures, water and wind exposure, exhaust from diesel and gas combustion, and the like. It is also desirable to provide signage that is resistant to rot and delaminate while simultaneously enhancing the look of the surrounding environment.

### SUMMARY

The present invention meets the current identified needs in the industry for cost-effective, high durability signage. The present invention is directed to a method for manufacturing high durability signage by coating at least a portion of an exposed surface layer of a thermoplastic substrate material, such as a sheet of the substrate material, with an aliphatic urethane composition to create an interface layer, coating a least a portion of the interface layer with at least one ink layer, and coating the at least one ink layer, and any exposed interface layer not having the at least one ink layer, with an aliphatic urethane composition to create an encapsulation layer. In some aspects, the thermoplastic substrate material is a sheet and at least one side of the thermoplastic sheet is coated with the aliphatic urethane composition to create the interface layer. In some aspects, both sides of the thermoplastic sheet are coated with the aliphatic urethane composition to create the interface layer. In still other aspects, both sides of the thermoplastic sheet and one or more edges of the thermoplastic sheet are coated with the aliphatic urethane composition to create the interface layer. In some aspects, at least a portion of at least one side of the thermoplastic sheet having the interface layer is coated with at least one ink layer.

In some aspects, the thermoplastic substrate material is a sheet and at least a portion of both sides of the thermoplastic sheet having the interface layer are coated with at least one ink layer, such that any portion of the interface layer not coated with the at least one ink layer provides an exposed interface layer on one or both sides of the thermoplastic sheet. The interface layer and any exposed interface layers may be coated with the aliphatic urethane composition to create the encapsulation layer.

In some other aspects, the thermoplastic substrate material is a sheet and at least one side of the thermoplastic sheet has the interface layer coated with at least one ink layer over substantially the entirety of the interface layer, such that there is essentially no exposed interface layer on that respective side of the thermoplastic sheet. The interface layer and any minimal exposed interface layer on that respective side of the thermoplastic sheet may be coated with the aliphatic urethane composition to create the encapsulation layer. In some aspects, the other side of the thermoplastic sheet may have the interface layer with or without at least one ink layer, such that any exposed interface layer and the at least one ink layer may be coated with the aliphatic urethane composition to create the encapsulation layer.

In some aspects of the present invention, the aliphatic urethane composition is essentially devoid of any pigments, colorants, dyes, or combination thereof, to provide a substantially clear coat layer upon application and being allowed to dry as a film. In some aspects, the aliphatic urethane composition is applied to the thermoplastic substrate material, interface layer, exposed interface layer and/or the at least one ink layer, to provide a clear coat layer.

In some aspects, the interface layer is a clear coat layer, such that the interface layer allows the pigments, colorants, dyes, or combinations thereof, of the thermoplastic substrate material to be visible through the interface layer. In some aspects, any portions of the thermoplastic substrate material that are visible through the clear coat layer of the interface layer is proximately located where one or more ink layers are not applied to the interface layer.

In some aspects, the encapsulation layer and the interface layer are both clear coat layers, such that the clear coat encapsulation and interface layers allow the pigments, colorants, dyes, or combination thereof, of the thermoplastic substrate material to be visible through the clear coat encapsulation and interface layers. In some aspects, the portions of the thermoplastic substrate material that are visible through the clear coat interface and encapsulation layers are proximately located where one or more ink layers are not applied to the interface layer.

In some aspects, the at least one ink layer and any exposed interface layer is coated with one or more layers of the aliphatic urethane composition to create a clear encapsulation layer. In some aspects, the at least one ink layer and any exposed interface layer is coated with two or more layers of the aliphatic urethane composition to create a clear encapsulation layer.

In some aspects, the coating process allows for the use of at least one color, in some aspects two or more colors, and in some other aspects, a multitude of color options that can be ink printed directly onto the interface layer, which has been coated directly onto the thermoplastic substrate material, to provide desired signage.

In some aspects of the present invention, the high durability signage contains at least one layer of a thermoplastic substrate material, a first coating of an aliphatic urethane composition on at least one side of the thermoplastic layer, an ink layer coated on at least a portion of the first aliphatic urethane coating, and a second coating of an aliphatic urethane composition on the ink layer and any portion of the first aliphatic urethane coating that was not coated with the ink layer. In some aspects, the first aliphatic urethane coating is directly coated onto substantially one side of the thermoplastic substrate material, in some aspects one side of a thermoplastic sheet, in some aspects substantially both sides of the thermoplastic substrate material, in some aspects both sides of the thermoplastic sheet. In some aspects, the ink layer is coated on substantially the entire first aliphatic urethane coating on at least one side of the thermoplastic substrate material, in some aspects at least one side of the thermoplastic sheet, in some other aspects both sides of the thermoplastic substrate material, in some aspects both sides of the thermoplastic sheet. In some aspects, the first and second aliphatic urethane coatings encapsulate the ink layer.

In some aspects of the present invention, the high durability signage contains at least one layer of a thermoplastic material, a first coating of an aliphatic urethane composition on both sides of the thermplastic layer, an ink layer coated on at least a portion of at least one side of the aliphatic urethane coating, and a second coating of an aliphatic urethane composition on the ink layer and any portion of the first aliphatic urethane coating that was not coated with the ink layer. In some aspects, the ink layer is coated on substantially the entire first aliphatic urethane coating. In some aspects, the first and second aliphatic urethane coatings encapsulate the ink layer.

In some aspects, the according to the method for manufacturing a laminated signage of the present disclosure, it is possible to make laminated signage with excellent interlayer adhesion that provides high durability to the signage, such that the signage is resistant to warpage, fading, rot and/or delaminate.

In some aspects, the at least one ink layer is applied onto at least a portion of the interface layer by inkjet printing, screen printing, electrostatic printing, digital printing, or the like. In some aspects, the at least one ink layer is printed onto substantially the entire interface layer. In some aspects, the at least one ink layer comprises one color. In some aspects, the at least one ink layer comprises two or more colors. In some aspects, the at least one ink layer comprises a plurality of colors. In some aspects, the ink layer comprises one or more ink layer coatings comprising at least one color, in some aspects, two or more colors, and in some other aspects a plurality of colors.

In some aspects, the thermoplastic substrate material comprises a sheet of a thermoplastic substrate material, such that the thermoplastic sheet has two side layers that are capable of being coated. In some aspects, the thermoplastic material may comprise high-density polyethylene, acrylonitrile butadiene styrene, thermoplastic polyolefin, or the like. In some aspects, the thermoplastic material has a dyne level (mN/m) using ASTM Standard D2578 of less than 40, in some aspects less than 38, and in some aspects less than 36.

In some aspects, the thermoplastic sheet has a thickness between about 1.5 and about 100 millimeters, in some aspects between about 3 and about 50 millimeters, in some aspects between about 4.5 and about 20 millimeters, in some aspects between about 5 and about 15 millimeters, and in some other aspects between about 6 and about 12 millimeters.

In some aspects, the aliphatic urethane composition applied to the thermoplastic sunstrate material to create the interface layer contains pendant hydroxyl groups that can be crosslinked with one or more activators, which can be initiated by UV irradiation with an irradiance less than 0.5 J/cm², partitioning between the phases and/or the generation of other functional groups by the reaction of the crosslinker with the backbone by the hydroxyl functionality of the aliphatic urethane composition. In some aspects, the interface layer is cured prior to the ink layer being applied.

In some aspects, the at least one ink layer comprises a material that is compatible with the interface layer, such as a liquid plastic or other polymer material in liquid form. In some aspects, the ink layer may be a UV ink layer that cures upon UV irradiation with an irradiance less than 0.5 J/cm².

In some aspects, the aliphatic urethane composition applied to the ink layer and any exposed interface layer to create the encapsulation layer contains pendant hydroxyl groups that can be crosslinked with one or more activators, which can be initiated by UV irradiation with an irradiance less than 0.5 J/cm², partitioning between the phases and/or the generation of other functional groups by the reaction of the crosslinker with the backbone by the hydroxyl functionality of the aliphatic urethane composition. In some aspects, the encapsulation layer has inter-layer crosslinking with the ink layer and/or the interface layer.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a partial cross sectional diagram view of the high durability signage having an ink layer on one side according to certain embodiments of the present invention.

FIG. 2 is a partial cross sectional diagram view of the high durability signage having an ink layer on both sides according to certain embodiments of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

The present inventors have surprising discovered a coating process for thermoplastic materials to provide ink printed thermoplastic signage that has high durability when exposed to exterior environmental weather and conditions. In some aspects, the high durability signage has reduced warpage and/or fading when exposed to all weather types and environmental conditions, including ultraviolet light, high temperatures, low temperatures, temperature cycling between low and high temperatures, water and wind exposure, exhaust from diesel and gas combustion, and the like. In some aspects, the high durability signage of the present invention is also resistant to rot and delaminate.

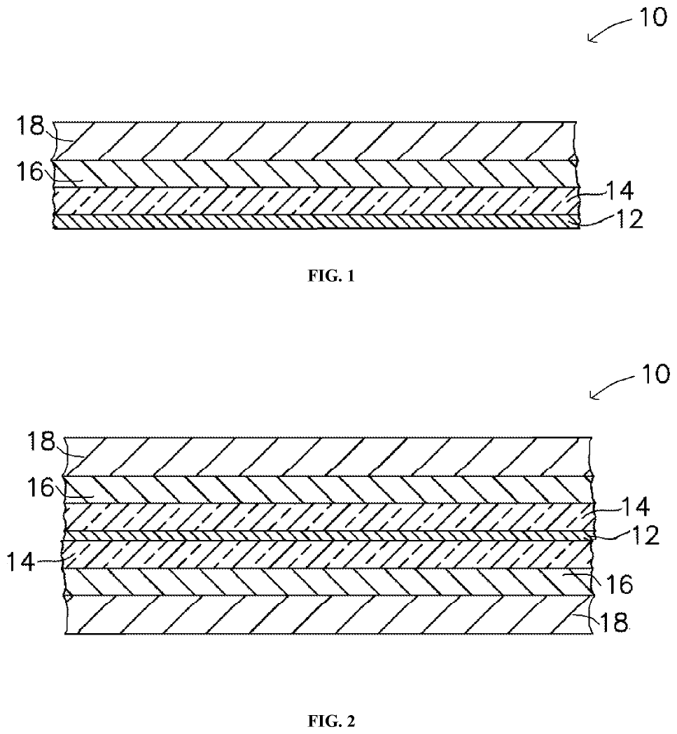

Referring now to the cross sectional diagram views of FIGS. 1 and 2, the high durability signage 10 generally comprises a thermoplastic substrate material layer 12, at least one interface layer 14 coated onto the substrate layer 12, at least one ink layer 16 coated onto the at least one interface layer 14, and at least one encapsulation layer 18 coated onto the at least one ink layer 16. In some aspects, the at least one ink layer 16 does not coat the entirety of the at least one interface layer 14, such that the interface layer 14 may comprise one or more portions of exposed interface layer (not shown). The at least one encapsulation layer 18 preferably coats the interface layer 14 and any portions of exposed interface layer.

In some preferred aspects, the at least one interface layer 14 is directly coated onto the substrate layer 12, the at least one ink layer 16 is directly coated onto at least a portion of the at least one interface layer 14, and the at least one encapsulation layer 18 is directly coated onto the at least one ink layer 16 and any exposed interface layer.

The thermoplastic substrate material is preferably a sheet such that the thermoplastic sheet 12 has two exposed surfaces that are capable of being coated. In some aspects, only one side of the thermoplastic sheet contains the coating layering shown in FIG. 1. In some other preferred aspects, the thermoplastic sheeting contains the coating layering on both sides, as shown in FIG. 2.

While not shown, it is also contemplated that in instances of the ink layer 16 applied to the interface layer 14 on one side of substrate layer 12, the opposite side may be coated with only the interface layer 14, the encapsulation layer 18, or both the interface layer 14 and the encapsulation layer 18. In some other aspects, one side of the thermoplastic sheet may remain exposed with no coating layer. As used herein, the term “exposed” shall be understood to mean a portion of the respective layer that remains uncoated.

The at least one ink layer 16 may be coated onto one or more portions of the interface layer 14 to provide the desired signage content, such as symbols, letters, numbers and the like. In some aspects, the ink layer 16 may comprise two or more ink layers, such that only a portion of one ink layer 14 is coated by a subsequent ink layer 14 to provide different ink layered colorings.

The method for manufacturing the high durability signage 10 includes coating at least a portion of the substrate layer 12 with at least one layer of an aliphatic urethane composition to create the interface layer 14, coating a least a portion of the interface layer 14 with at least one ink layer 16, and coating the at least one ink layer 16 and any exposed interface layer 14 with one or more coatings of an aliphatic urethane composition to create an encapsulation layer 18.

In some aspects, at least one side of the substrate layer 12 is coated with the aliphatic urethane composition to create the interface layer 14. In some alternative aspects, both sides of the substrate layer 12 may be coated with the aliphatic urethane composition to create the interface layer 14 on both sides of the substrate layer 12. In some aspects, the aliphatic urethane composition used to create the interface layer 14 is essentially devoid of any pigments, colorants, dyes, or combinations thereof, such that the interface layer 14 applied to the substrate layer 12 is a clear coat.

In some aspects, one side of the substrate layer 12 having the interface layer 14 is coated with at least one ink layer 16, such as depicted in FIG. 1. In some alternative aspects, both sides of the substrate layer 12 having the interface layer 14 are coated with at least one ink layer 16, such as depicted in FIG. 2.

The at least one ink layer 16 can be applied onto at least a portion of the interface layer 14 by inkjet printing, screen printing, electrostatic printing, digital printing, or the like. Preferably the ink layer 16 is applied to the interface layer 14 by digital printing. The ink layer 16 may comprise a single color up to a different array of colors, including black, white, red, orange, yellow, green, blue, indigo, violet, and various mixtures and shades thereof.

The at least one ink layer 16 may be printed onto substantially the entire interface layer 14. In some aspects, the ink layer 16 comprises two or more ink layers 16 with each ink layer 16 having a different color and/or shade than the adjacent ink layer 16. In some preferred aspects, the ink layer 16 is capable of being printed using two or more colors or shades of the same color, even more preferably a multitude of colors and shades thereof, such that ink layer 16 comprises a single ink layer 16 having two or more colors or shades thereof.

In some aspects, the at least one ink layer 16 and any exposed interface layer 14 are coated with one or more layers of the aliphatic urethane composition to create the encapsulation layer 18. In some aspects, the at least one ink layer 16 and any exposed interface layer 14 are coated with two or more layers of the aliphatic urethane composition to create the encapsulation layer 18. In some aspects, the aliphatic urethane composition used to create the encapsulation layer 18 is essentially devoid of any pigments, colorants, dyes, or combinations thereof, such that the encapsulation layer 18 is a clear coat layer.

The substrate layer 12 preferably comprises a thermoplastic material. In some preferred aspects, the substrate layer 12 comprises a sheet of a thermoplastic material. The thermoplastic material may comprise high-density polyethylene (HDPE), acrylonitrile butadiene styrene (ABS), thermoplastic polyolefin (TPO), or other desirable thermoplastic materials or combinations thereof.

The thermoplastic material preferably has a dyne level (mN/m) using ASTM Standard D2578 of less than 40, in some aspects less than 38, and in some aspects less than 36.

The thermoplastic material preferably has a sheet thickness between about 1.5 and about 100 millimeters, in some aspects between about 3 and about 50 millimeters, in some aspects between about 4.5 and about 20 millimeters, in some aspects between about 5 and about 15 millimeters, and in some other aspects between about 6 and about 12 millimeters. The length and width of the thermoplastic sheet can be various dimensions depending upon the intended use of the signage.

The aliphatic urethane composition applied to the substrate layer 12 to create the interface layer 14 contains pendant hydroxyl groups that can be crosslinked with one or more activators. Preferably, the aliphatic urethane composition applied to create the interface layer 14 has a film thickness between about 1 micron to about 100 microns, in some aspects between about 2 microns and about 50 microns, and in some other aspects between about 5 microns and about 25 microns. Once applied to the substrate layer 12, the aliphatic urethane composition is preferably allowed to dry or cure prior to the ink layer 16 being applied. In some aspects, the aliphatic urethane composition is cured by UV irradiation with an irradiance less than 0.5 J/cm² that allows crosslinking. The aliphatic urethane composition may also be crosslinked by partitioning between the phases and/or the generation of other functional groups by the reaction of the crosslinker with the backbone by the hydroxyl functionality of the aliphatic urethane composition.

The ink layer 16 preferably comprises a material that is compatible with the interface layer 14, such as a liquid plastic or other polymer material in liquid form. In some aspects, the ink layer 16 may be a UV ink layer that cures upon UV irradiation with an irradiance less than 0.5 J/cm². Once applied to the interface layer 14, the ink layer 16 is preferably allowed to dry or cure prior to the encapsulation layer 18 is applied.

The aliphatic urethane composition applied to the ink layer 16 and any exposed interface layer 14 to create the encapsulation layer 18 may also contain pendant hydroxyl groups that can be crosslinked with one or more activators, which can be initiated by UV irradiation with an irradiance less than 0.5 J/cm², partitioning between the phases and/or the generation of other functional groups by the reaction of the crosslinker with the backbone by the hydroxyl functionality of the aliphatic urethane composition. In some aspects, the encapsulation layer 18 has inter-layer crosslinking with the ink layer 16 and/or the interface layer 14.

In some preferred aspects, the aliphatic urethane composition is EFI Armor UV High E 2296, commercially available from Electronics for Imaging, Inc., which is a very flexible UV coating.

In some preferred aspects, the aliphatic urethane composition will have an activator or crosslinking resin added for adhesion and increased water resistance. It is contemplated that Polycup™ water-based resins may be added that are reactive with amine, carboxyl, hydroxyl and thiol functionality, which are responsible alternatives to traditional crosslinking resins, which are known to one of ordinary skill in the art. Without wishing to be bound by theory, it is believed that the activator facilitates crosslinking of the aliphatic urethane composition

The method for manufacturing the high durability signage 10 of the present invention may be conducted by single individual signs. Alternatively, the substrate layer 12 may be provided in a roll or size larger than the final desired size, such that at least the interface layer 14 is applied prior to the substrate layer 12 being cut to the desired size. In some aspects, both the interface layer 14 and the ink layer 16 are applied prior to the substrate layer 12 being cut to the desired size. In some alternative embodiments, each of the interface layer 14, ink layer 16 and encapsulation layer 18 are applied prior to the final cutting of the desired signage size.

In some aspects, the ink layer 16 of the signage 10 is legible to the eye of an ordinary observer from at least 10 feet away after being exposed to the natural outdoor environment for at least 1 year, in some aspects at least 2 years, in some aspects at least 3 years, in some aspects at least 4 years, in some aspects at least 5 years, in some aspects at least 6 years, in some aspects at least 7 years, in some aspects at least 8 years, in some aspects at least 9 years, and in some aspects at least 10 years. In some aspects, the ink layer 16 of the signage 10 is legible to the eye of an ordinary observer from at least 10 feet away after being exposed to the natural outdoor environment for at least 1 year up to about 100 years, in some aspects up to about 75 years, in some aspects up to about 50 years, in some aspects up to about 35 years, in some aspects up to about 25 years, and in some other aspects up to about 20 years.

### Example

A digitally-printed sign sample was prepared from a yellow-colored high density polyethylene material having a thickness of 0.125 inches. The yellow-colored high density polyethylene material was coated with a layer of an aliphatic urethane composition (EFI Armor UV High E 2296, commercially available from Electronics for Imaging, Inc.) with an added activator to provide an interface layer. The interface layer was digitally printed with an ink set using black and red colors to provide an ink layer. The ink layer and any exposed interface layer were coated with a layer of the same aliphatic urethane composition and activator to provide an encapsulation layer.

A screen-printed sign sample was prepared from a white-colored high density polyethylene material having a thickness of 0.125 inches having red and blue coloring for comparative purposes. The screen-printed sign sample did not utilize any aliphatic urethane composition layers. The screen printed sign sample is known to withstand the natural outdoor environment such that the printed graphics are still legible to an ordinary observer from at least 10 feet away after a minimum of 10 years.

Both the digitally-printed sign sample and the screen-printed sign sample were cut into sample strips for comparative testing purposes by providing a control sample and a test sample for each of the signs. The digitally-printed control sample and the screen-printed control sample were not exposed to any weatherability conditions. The digitally-printed test sample and the screen-printed test sample were both subjected to accelerated weathering conditions using ASTM Standard G155 (Standard Practice for Operating Xenon Arc Light Apparatus for Exposure of Non-Metallic Materials), whereby the Xenon Arc UV light source simulates exposure to natural sunlight and moisture on an accelerated basis. The digitally-printed and the screen-printed test samples were both placed at the same time into a UV weather chamber with ultra violet bulbs and occasional water spray to simulate rain, and consisted of a 500, 1000, and 2000-hour test analysis. The digitally-printed test sign retained the coating and remained legible as compared to the control. The digitally-printed test sign also performed as well as the known screen-printed sign sample.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above.

The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method for manufacturing a high durability signage, the method comprising:
providing a thermoplastic substrate material having at least one exposed surface layer;
applying at least one coat of a first aliphatic urethane composition to at least a portion of the at least one exposed surface layer of the thermoplastic substrate material to create an interface layer;
applying at least one coat of an ink material to at least a portion of the interface layer to create an ink layer and an optional exposed interface layer; and
applying at least one coat of a second aliphatic urethane composition to the ink layer and any exposed interface layer to create an encapsulation layer.

2. The method of claim 1, wherein the ink material comprises at least one color.

3. The method of claim 2, wherein the thermoplastic substrate material is a sheet having two sides, and the ink material is coated directly onto the interface layer on at least one side of the thermoplastic substrate material.

4. The method of claim 3, wherein the ink material is coated directly onto the interface layer on both sides of the thermoplastic substrate material.

5. The method of claim 1, wherein the at least one coat of the ink material is applied to the interface layer by inkjet printing, screen printing, electrostatic printing, or digital printing.

6. The method of claim 1, wherein the thermoplastic substrate material comprises high-density polyethylene, acrylonitrile butadiene styrene, or thermoplastic polyolefin

7. The method of claim 6, wherein the thermoplastic substrate material has a dyne level (mN/m) using ASTM Standard D2578 of less than about 40.

8. The method of claim 7, wherein the thermoplastic substrate material is in the form of a sheet having a thickness between about 1.5 millimeters and about 12 millimeters.

9. The method of claim 1, wherein the first and second aliphatic urethane compositions contain pendant hydroxyl groups that can be crosslinked with one or more activators, which can be initiated by UV irradiation with an irradiance less than 0.5 J/cm², partitioning between the phases and/or the generation of other functional groups by the reaction of the crosslinker with the backbone by the hydroxyl functionality of the aliphatic urethane composition.

10. The method of claim 1, wherein the first and second aliphatic urethane compositions of the interface and encapsulations layers are essentially devoid of any pigments, colorants, dyes, or combinations thereof.

11. The high durability signage of claim 1, wherein the aliphatic urethane composition of the interface layer and the encapsulation layer is the same material.

12. A high durability signage comprising:
a substrate layer having a first dried film coating of an aliphatic urethane composition that provides an interface layer between the substrate layer and an ink material in direct contact with the interface layer; and
a second dried film coating of an aliphatic urethane composition that provides an encapsulation layer over the ink material and any exposed interface layer.

13. The high durability signage of claim 12, wherein the ink material comprises at least one color directly coated onto the interface layer.

14. The high durability signage of claim 13, wherein the ink material is directly coated onto the interface layer on at least one side of the substrate layer.

15. The high durability signage of claim 14, wherein the ink material is directly coated onto the interface layer on both sides of the substrate layer.

16. The high durability signage of claim 12, wherein the substrate layer comprises a thermoplastic material having a dyne level (mN/m) using ASTM Standard D2578 of less than about 40.

17. The high durability signage of claim 16, wherein the substrate layer is a thermoplastic material chosen from high-density polyethylene, acrylonitrile butadiene styrene, and thermoplastic polyolefin.

18. The high durability signage of claim 12, wherein the substrate layer is a thermoplastic material in the form of a sheet having a thickness between about 1.5 and about 12 millimeters.

19. The high durability signage of claim 12, wherein the first and second dried film coatings of the aliphatic urethane composition are essentially devoid of any pigments, colorants or dyes.

20. The high durability signage of claim 12, wherein the signage is capable of withstanding weather and environmental conditions without warping, fading, rotting and/or delaminating for at least 10 years.
